(19) United States
(12) Patent Application Publication
(10) Pub. No.: US 2018/0101581 A1
(43) Pub. Date: Apr. 12, 2018

(54) SYSTEM AND METHOD FOR DATA MANAGEMENT

(71) Applicant: HITACHI, LTD., Tokyo (JP)

(72) Inventors: Kunihiko TOUMURA, Tokyo (JP); Tatsuhiko MIYATA, Tokyo (JP); Yoshiki MATSUURA, Tokyo (JP)

(73) Assignee: HITACHI, LTD., Tokyo (JP)

(21) Appl. No.: 15/480,455

(22) Filed: Apr. 6, 2017

(30) Foreign Application Priority Data
Oct. 6, 2016 (JP) 2016-197783

(51) Int. Cl. G06F 17/30

(52) U.S. Cl. CPC G06F 17/30542; G06F 17/30421

(57) ABSTRACT

A data management system includes: a data storage unit 1 configured to store: a data group 102 that is a group of data provided with at least one metadata, and one or more metadata systems 103(1), 103(2) for interpreting the metadata, and to search for the data group with a selected metadata system, in accordance with a query; an impact evaluation unit 2 configured to obtain a variance between a plurality of metadata systems serving as comparison targets when the plurality of metadata systems execute the same query for the data storage unit; and a metadata system management unit 3 configured to select a metadata system, based on the variance obtained by the impact evaluation unit.

### INCORPORATION BY REFERENCE

This application claims priority based on Japanese patent application, No. 2016-197783 filed on Oct. 6, 2016, the entire contents of which are incorporated herein by reference.

### BACKGROUND

The present invention relates to a system and a method for data management.

Advancement of communication network techniques has made collection and analysis for information from sensors and devices from all over the world much easier. Collective analysis on various types of information enables an operator of a data management system to find association from a comprehensive point of view and achieve system optimization.

Data (raw data) simply collected from sensors and devices is provided with no associated information (metadata) required in later processing such as analysis. The raw data provided with metadata can be associated with another piece of data, and thus has a higher value.

For example, data with a simple 32-bit string “0x42140000” would not be so valuable. When the bit string data is provided with metadata indicating that the data is a single-precision floating point, the bit string can be interpreted as data representing a numerical value “37.0”.

Furthermore, the raw data can have an even higher value when provided with metadata indicating that the bit string is temperature data, described in Celsius, is information detected by a sensor disposed at a certain position, or is data measured at a certain time point. The metadata can be provided at a time point when the raw data is generated, or after the raw data has been collected. Hereinafter, the raw data may be simply referred to as data.

Metadata provided to raw data has a system (metadata system) with which the data can have meanings or can be associated with another piece of data. For example, it is defined in the metadata system that a concept A is subordinate to another concept B, or that two concepts with different names actually have the same meaning.

The metadata system can be used for estimation to associate data with another piece of data in a wider range than in a case where only the metadata directly provided to the data is used. In this context, for example, positional information may be associated with an administrative division of a region including the position. Furthermore, for example, an average temperature of a certain district may be obtained with an estimation based on the association with a larger administrative division including the region.

In a data management system that independently collects and analyzes data, metadata and a metadata system provided to each raw data are fixed, and the metadata or metadata system provided are rarely changed.

Still, an additional function of enabling the metadata and the metadata system to be changed after establishment of the data management system would make way for a wider range of use of data through new association that has not been contemplated when the system was designed.

To achieve this, techniques for supporting provision of new metadata to existing data have conventionally been proposed. Japanese Patent Application Laid-open No. 2007-115069 discloses a method of selecting data estimated to be related to provision of metadata, and presenting the data to a user, so that the user can efficiently provide the metadata. With this technique, the user can receive recommendation about appropriate data to which metadata is provided.

### SUMMARY

The conventional technique described in Japanese Patent Application Laid-open No. 2007-115069 can recommend new metadata to raw data from an existing metadata group and metadata system, but cannot support a system administrator making new changes in the existing metadata system.

Furthermore, an impact of changing a metadata system on the system cannot be recognized. For this reason, it would be substantially difficult for an administrator who is concerned about the negative impact to change the metadata system.

The present invention is made in view of the above, and an object of the present invention is to provide a system and a method of data management with which a variance between cases where a plurality of metadata systems serving as comparison targets are used is obtained to support the selection of a metadata system, so that a user can enjoy higher usability. A further object of the present invention is to provide a system and a method of data management with which an index for selecting a metadata system is provided, so that changes in a metadata system can be facilitated.

To solve the problems described above, a data management system according to the present invention is a data management system that manages data including metadata and includes: a data storage unit configured to store: a data group that is a group of data provided with at least one metadata; and one or more metadata systems for interpreting the metadata, and to search for the data group with a selected metadata system, in accordance with a query; an impact evaluation unit configured to obtain a variance between a plurality of metadata systems serving as comparison targets when the plurality of metadata systems execute a same query for the data storage unit; and a metadata system management unit configured to select a metadata system, based on the variance obtained by the impact evaluation unit.

In the present invention, the variance between the plurality of metadata systems serving as the comparison targets when the plurality of metadata systems execute the same query is obtained, and a metadata system can be selected based on the variance. Thus, a user managing the metadata system can be supported, and thus can enjoy higher usability.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an overall configuration of a data management system;

FIG. 2 is a diagram illustrating a configuration of a data collection apparatus;

FIG. 3 is a diagram illustrating a configuration of a data storage apparatus;

FIG. 4 is a diagram illustrating a configuration of a query processing apparatus;

FIG. 5 is a diagram illustrating a configuration of a metadata system management system;

FIG. 6 is a diagram illustrating a configuration of an impact evaluation apparatus;

FIG. 7 is a flowchart illustrating processing executed by raw data registration processing;

FIG. 8 illustrates an example of a template database;

FIG. 9 is a diagram illustrating an example in which raw data is provided with metadata and stored;

FIG. 10 illustrates an example of a database storing raw data provided with metadata;

FIG. 11 illustrates an example of a metadata system database;

FIG. 12 illustrates an example of a query history database;

FIG. 13 is a flowchart of query processing;

FIGS. 14A and 14B respectively illustrate a query example and a corresponding result example;

FIG. 15 is a flowchart of metadata system management processing and impact evaluation processing;

FIG. 16 illustrates an example of a metadata system management screen presented to a user;

FIG. 17 is a representative sequence diagram illustrating of the entire operation of the data management system;

FIG. 18 is a flowchart of metadata system management processing according to a second embodiment;

FIG. 19 is a flowchart of metadata system management processing and impact evaluation processing according to a third embodiment;

FIG. 20 is a flowchart of metadata system management processing, impact evaluation processing, and data storage processing according to a fourth embodiment;

FIG. 21 is a flowchart of the entire processing for managing metadata systems;

FIG. 22 is a flowchart of metadata system management processing and impact evaluation processing according to a fifth embodiment; and

FIG. 23 is a flowchart of metadata system management processing and impact evaluation processing according to a sixth embodiment.

### DETAILED DESCRIPTION OF THE EMBODIMENTS

Embodiments of the present invention are described below with reference to the drawings. As described later, in the embodiments, management of a metadata system by a user is supported with an impact of changing the metadata system estimated before the metadata system is changed.

To achieve this, a data management system according to the embodiments includes: a data register/search unit 101 (also referred to as a data storage function 101), an impact evaluation unit 201 (also referred to as an impact evaluation function 201), and a metadata system management unit 301 (also referred to as a metadata system management function 301).

The data storage function 101 stores therein one or more metadata systems 103 and a data group 102 provided with metadata, and search is executed with the data group 102 combined with one of the metadata systems 103. The impact evaluation function 201 obtains a variance between the plurality of metadata systems 103(1) and 103(2) when the plurality of metadata systems 103(1) and 103(2) execute the same query for the data storage function 101. The variance may be hereinafter referred to as difference. The metadata system management function 301 presents the variance, presented by the impact evaluation function 201, to a user such as a system administrator, and issues an instruction indicating one or more metadata systems 103 selected by the user, as the metadata system of the data storage function 101. Thus, the determination of the user can be supported with the impact of changing the metadata system presented beforehand.

The query, employed by the plurality of metadata systems serving as comparison targets, is a test query for estimating the impact of the changing the metadata system. The test query may be prepared before a test, or generated at the time of the test. In the present embodiment, a history of the queries used in the past is managed, and the test query is selected from the query history to be used.

In one embodiment described below, the plurality of metadata systems serving as the comparison targets, are concurrently operated, and a variance in the search result over a predetermined period is examined. The user determines the impact of changing the metadata system, based on a variance in the operation result over the predetermined period. Thus, the variance between the plurality of metadata systems can be obtained while the metadata systems are actually operating concurrently, to support the determination of the user.

In another embodiment described below, the query is issued for a plurality of times to the plurality of metadata systems serving as the comparison targets. A second query is selected based on the search result corresponding to a first query and is issued to the plurality of metadata systems serving as the comparison targets, to obtain a second search result.

In the present embodiment with the configuration described above, a level of impact of changing the metadata system can be determined, so that changes in the metadata system can be facilitated. Thus, data utilization creating new values can be additionally introduced.

### Embodiment 1

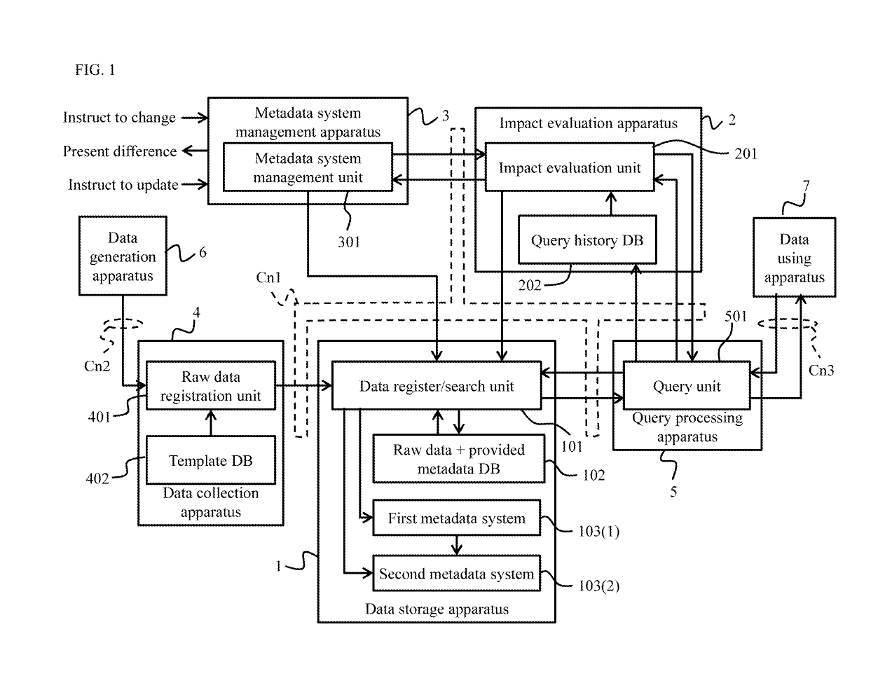

Embodiment 1 is described with reference to FIGS. 1 to 17. FIG. 1 illustrates an overall configuration of an information processing system including a data management system.

The data management system that manages data including metadata includes, for example, a data storage apparatus 1, an impact evaluation apparatus 2, and a metadata system management apparatus 3. The data management system may further include a data collection apparatus 4 and a query processing apparatus 5. A data generation apparatus 6 and a data using apparatus 7, which are generally not included in the data management system, but the apparatuses 6 and 7 may be included in the data management system in some cases.

An example of configurations of the data storage apparatus 1, the impact evaluation apparatus 2, the metadata system management apparatus 3, the data collection apparatus 4, and the query processing apparatus 5 is described later in detail. As described later, the apparatuses 1 to 5 may be provided on different computers, or may be provided on a common computer. In a case described in the present embodiment, the apparatuses 1 to 5 are implemented with different computers.

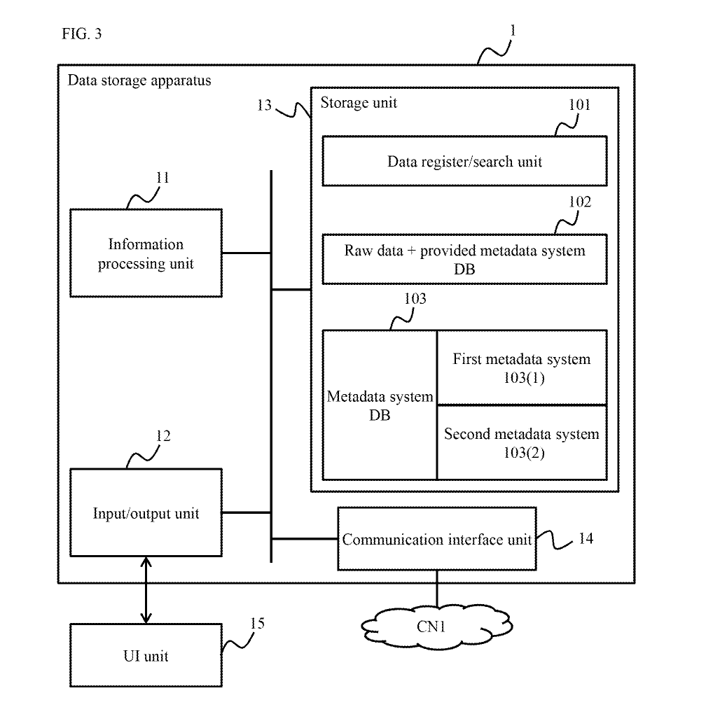

For example, the data storage apparatus 1 includes; the data register/search unit 101 that registers data and searches for the registered data; the database 102 that stores and manages raw data to which metadata is set; the first metadata system 103(1); and the second metadata system 103(2). An example of the configuration of the data storage apparatus 1 is described later with reference to FIG. 3. Hereinafter, “database” is abbreviated as DB.

A portion that implements a predetermined function may be referred to as “function”. For example, the data register/search unit 101 may be referred to as a data register/search function 101. The functions 101, 201, 301, 401 and 501 are implemented on the apparatuses 1, 2, 3, 4, and 5 formed as the computers. Thus, for example, a “data storage unit” may be the data storage apparatus 1, and an “impact evaluation unit” may be the impact evaluation apparatus 2.

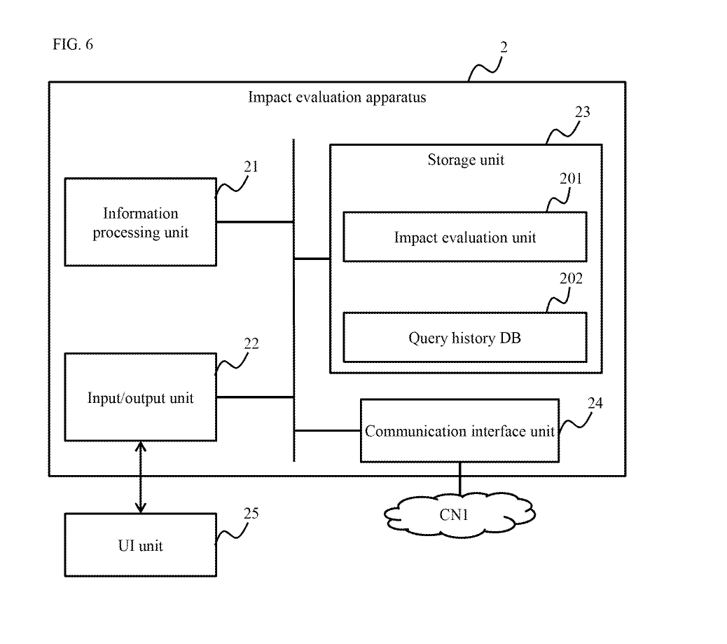

For example, the impact evaluation apparatus 2 includes: the impact evaluation unit 201 that evaluates an impact of changing a metadata system; and a query history DB 202 that stores and manages queries issued in the past. An example of the configuration of the impact evaluation apparatus 2 is described later in detail with reference to FIG. 6.

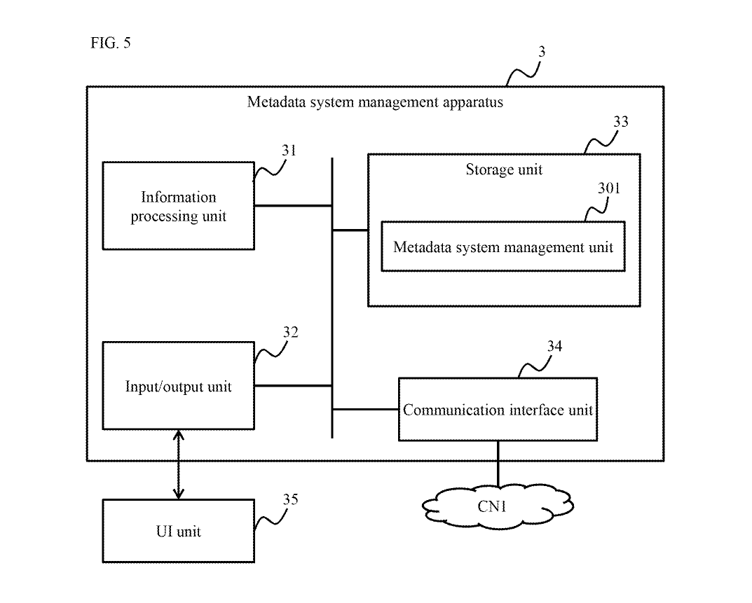

For example, the metadata system management apparatus 3 includes the metadata system management unit 301 that manages the metadata system based on an evaluation performed by the impact evaluation apparatus 2. An example of the configuration of the metadata system management unit 301 is described below in detail with reference to FIG. 5.

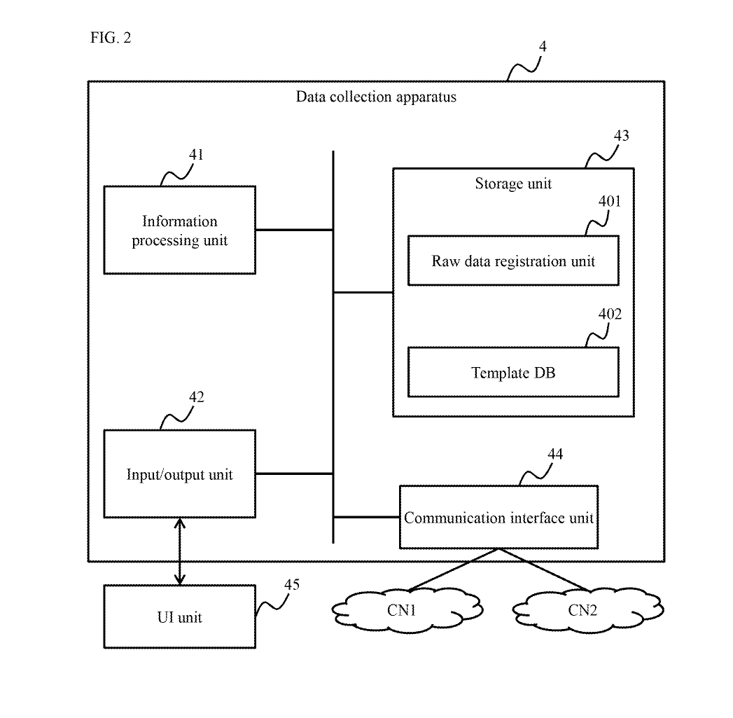

For example, the data collection apparatus 4 includes: a raw data registration unit 401 that registers raw data, received from the data generation apparatus 6, in the data storage apparatus 1; and a template DB 402. An example of the configuration of the data collection apparatus 4 is described later with reference to FIG. 2.

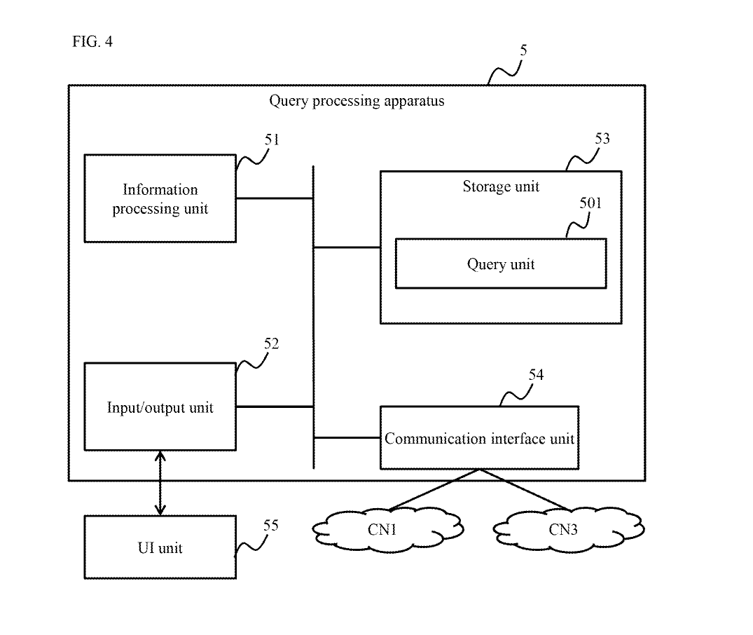

For example, the query processing apparatus 5 includes a query unit 501 that issues a query for data (raw data to which the metadata is set) stored in the data storage apparatus 1, and receives a result of the query (search result). An example of the configuration of the query processing apparatus 5 is described below in detail with reference to FIG. 4.

The data generation apparatus 6 is an apparatus that generates raw data. For example, the data generation apparatus 6 includes various sensors and various devices, and generates a measured value of a sensor and log information on an apparatus, as the raw data. Although FIG. 1 illustrates a single data generation apparatus 6, one or more data generation apparatuses 6 are connected to the data collection apparatus 4 in an actual configuration.

The data using apparatus 7 is an apparatus that uses a data group managed in the data management system and requests the query processing apparatus 5 to search for data. The data using apparatus 7 receives a search result from the query processing apparatus 5, and uses the search result for data analysis or the like. Although FIG. 1 illustrates a single data using apparatus 7, one or more data using apparatuses 7 are connected to the query processing apparatus 5 in an actual configuration.

A connection configuration of the apparatuses 1 to 7 is described. The data storage apparatus 1, the impact evaluation apparatus 2, and the metadata system management apparatus 3 are connected to each other through a communication network CN1. The data generation apparatus 6 and the data collection apparatus 4 are connected to each other through a communication network CN2. The data using apparatus 7 and the query processing apparatus 5 are connected to each other through a communication network CN3. The communication networks CN1 to CN3 may be different communication networks, or may be a common communication network.

An overview of an operation in the data management system is described. The data generation apparatus 6 transmits raw data to the data collection apparatus 4 through the communication network CN2. The data collection apparatus 4 provides metadata to the raw data on the basis of a template set in advance, and stores the resultant data in the data storage apparatus 1. For example, the data generation apparatus 6 may have a sensing function, a storage function, and a communication function. A detail description on an example of the configuration of the data generation apparatus 6 will be omitted.

The data using apparatus 7 requests the query processing apparatus 5 to search for data, through the communication network CN3. The query processing apparatus 5 requests the data storage apparatus 1 to search for data. Upon receiving a response to the query from the data storage apparatus 1, the query processing apparatus 5 transmits the content of the response to the data using apparatus 7. For example, the data using apparatus 7 is formed as a computer, and has a calculation processing function, a storage function, a communication function, and a user interface function. A detail description on an example of the configuration of the data using apparatus 7 will be omitted.

When the user changes the metadata system, the metadata system management apparatus 3 uses the data storage apparatus 1 and the impact evaluation apparatus 2 to examine the impact of changing the metadata system. The metadata system management apparatus 3 presents an examination result of the impact of changing the metadata system to the user. The user can instruct the metadata system management apparatus 3 to change or not to change the metadata system, after checking the examination result. Changing the metadata system set in the data storage unit 1 may be expressed as “updating the metadata system” in the description below.

FIG. 2 illustrates the configuration of the data collection apparatus 4. The data collection apparatus 4 has a configuration similar to that of a general computer. Specifically, for example, the data collection apparatus 4 includes an information processing unit 41, an input/output unit 42, a storage unit 43, and a communication interface unit 44 that are connected to each other through an internal bus. Furthermore, a user interface unit 45 is connected to the input/output unit 42. The user interface unit 45 is a device through which the user and the data collection apparatus 4 exchange information, and is formed as a display, a display device, a voice synthesis device, a printer, a keyboard, a switch, a touch panel, a voice recognition device, or the like for example. The communication interface unit 44 is connected to the communication network CN1 and the communication network CN2 and performs communications.

The storage unit 43 includes a rewritable storage medium such as a semiconductor memory and a hard disk, for example. For example, the storage unit 43 stores therein a program for implementing the raw data registration function 401 and the template DB 402. The raw data registration function 401 interprets a computer program, stored in the storage unit 43, with the information processing unit 41 to execute processing. This operation is hereinafter referred to as “the raw data registration function executes processing”.

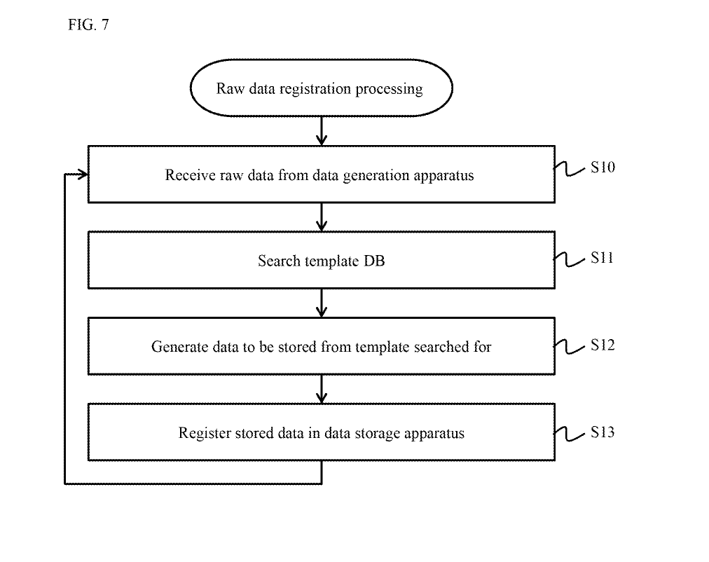

FIG. 7 is a flowchart illustrating processing executed by the raw data registration function 401. Upon receiving raw data from the data generation apparatus 6 (S10), the raw data registration function 401 searches the template DB 402 (S11). The template DB 402 stores a template of data to be stored used for the raw data received.

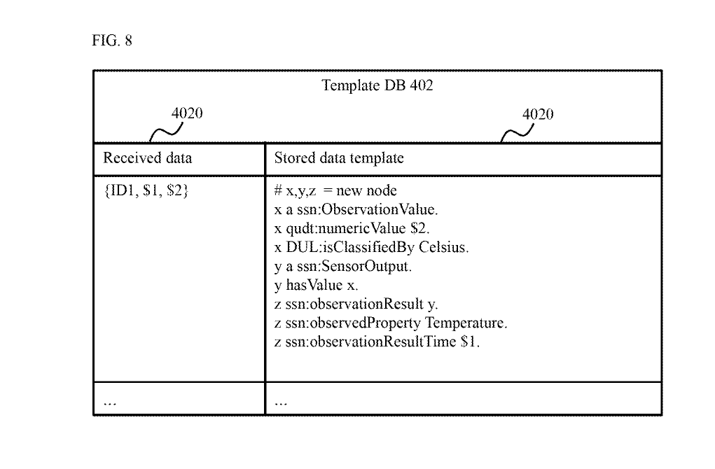

FIG. 8 illustrates an example of the template DB 402. In this example, the received data is described as a tuple. For example, a description “{ID1, $1, $2}” indicates an application is made for received data as “a tuple including three elements with the first element being “ID1””. Upon receiving the raw data corresponding to the description from the data generation apparatus 6, the data collection apparatus 4 uses a template of stored data corresponding to the raw data, and generates data to be stored in the data storage apparatus 1 (S12).

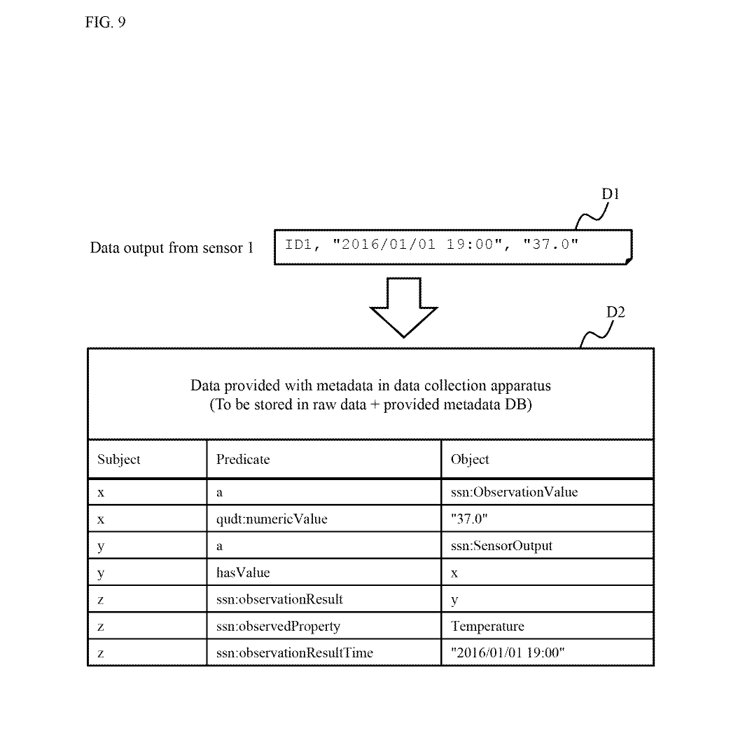

FIG. 9 illustrates an example of the stored data generated by using the template DB 402 illustrated in FIG. 8. In this example, a temperature sensor with an identifier “ID1” is described as the data generation apparatus 6.

The temperature sensor generates data D1 indicating that 37.0 degrees Celsius has been measured at a time point “2016/01/01 19:00”, and the data D1 is assumed to be received by the data collection apparatus 4. The raw data matches the first line in the template DB 402 illustrated in FIG. 8, and thus the data collection apparatus 4 performs conversion based on the template. Specifically, the data collection apparatus 4 generates data to be stored with the template of the stored data, with a portion of “$1” and a portion of “$2” respectively replaced with “2016/01/01 19:00” and “37.0” in information in a column of the received data. A lower side of FIG. 9 illustrates resultant data D2. Referring back to FIG. 7, the stored data generated by the data collection apparatus 4 through the procedure described above is transmitted to the data storage apparatus 1 to be registered (S13).

FIG. 3 illustrates the configuration of the data storage apparatus 1. For example, the data storage apparatus 1 includes an information processing unit 11, an input/output unit 12, a storage unit 13, and a communication interface unit 14 as in the configuration described above, and these units 11 to 14 are connected to each other through an internal bus. A user interface unit 15 is connected to the input/output unit 12. The information processing unit, the input/output unit, the storage unit, the communication interface unit, and the user interface unit are described above with reference to FIG. 2, and thus the detail description thereof will be omitted. The data storage apparatus 1 has the communication interface unit 14 connected to the communication network CN1.

The storage unit 13 stores therein: a computer program for implementing data registration and search function 101; the raw data+provided metadata DB 102; and the metadata system DB 103. In the present embodiment, the database is divided into the metadata system DB 103 and the raw data+provided metadata DB 102. Thus, version management can be easily performed for the metadata system only.

The raw data+provided metadata DB 102 stores and manages data (data such as data D2 illustrated in FIG. 9) received from the data collection apparatus 4.

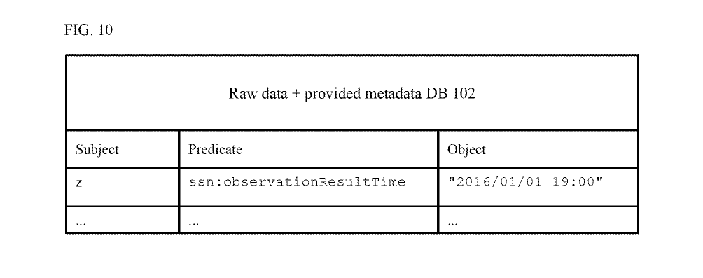

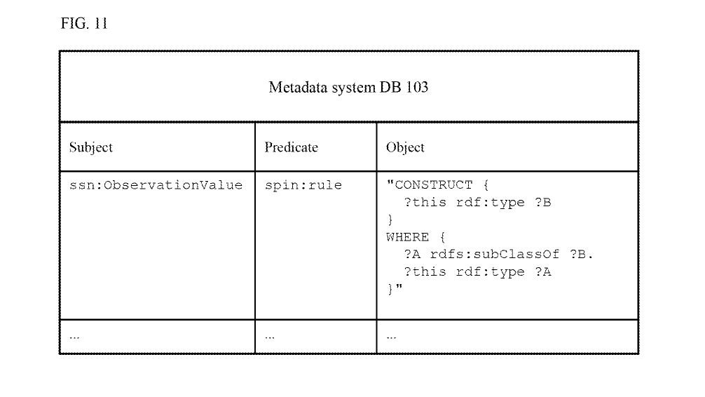

FIG. 10 illustrates an example of the configuration of the raw data+provided metadata DB 102. This DB 102 may also be described with a Resource Description Framework (RDF). FIG. 11 illustrates an example of the configuration of the metadata system DB 103. The metadata system can also be described with the RDF. The metadata system describes relevant information related to the data stored in the data storage apparatus 1 with three elements of subject, predicate, and object.

The metadata system DB 103 manages at least one metadata system. The metadata system DB 103 illustrated in FIG. 3 includes the first metadata system 103(1) and the second metadata system 103(2). In one example, the first metadata system 103(1) is set as a default metadata system, whereas the second metadata system 103(2) is a metadata system which is under review by the user for the change. In other words, the first metadata system 103(1) is a metadata system before the change or an existing metadata system, whereas the second metadata system 103(2) is a metadata system after the change or a new metadata system.

FIG. 4 illustrates the configuration of the query processing apparatus 5. For example, the query processing apparatus 5 may also include an information processing unit 51, an input/output unit 52, a storage unit 53, and a communication interface unit 54, and these units 51 to 54 are connected to each other through an internal bus. A user interface unit 55 is connected to the input/output unit 52. The communication interface unit 54 is connected to each of the communication network CN1 and the communication network CN3. The storage unit 53 stores therein a computer program for implementing the query function 501.

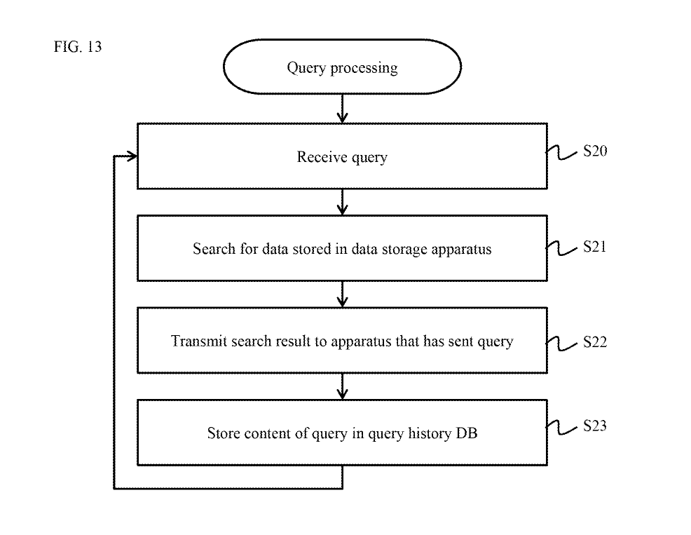

FIG. 13 is a flowchart of processing executed by the query function 501. Upon receiving a query from the data using apparatus 7, the query processing apparatus 5 transfers the received query to the data storage apparatus 1 (S20). Thus, the query processing apparatus 5 causes the data storage apparatus 1 to perform the search in accordance with the query (S21). Specifically, the data storage apparatus 1 uses the metadata system DB 103 and the raw data+provided metadata DB 102 to perform the search in accordance with the query received from the query processing apparatus 5. The search result thus obtained is transmitted from the data storage apparatus 1 to the query processing apparatus 5.

The query processing apparatus 5 transmits the search result, received from the data storage apparatus 1, to the data using apparatus 7 as a response (S22). As a final step, the content of the query to the data storage apparatus 1 is transmitted from the query processing apparatus 5 to the impact evaluation apparatus 2 to be registered in the query history DB 202 (S23).

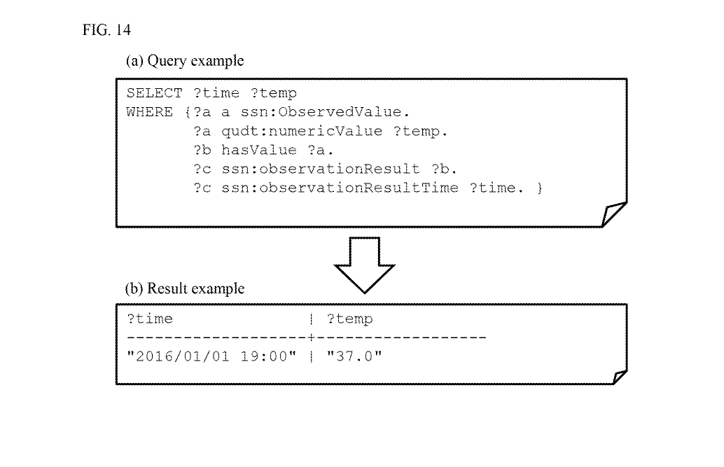

FIGS. 14A and 14B are diagrams illustrating a content of a query and a result obtained therewith. FIG. 14A illustrates a content of a query, and FIG. 14B illustrates a result of a search in response to the query. Although the content of the query is described with SPARQL (SPARQL Protocol and RDF Query Language), this should not be construed in a limiting sense, and other query languages may be used.

FIG. 14A illustrates the query for instructing searching for data on an observation result, in which a time point and a temperature are associated with each other, and returning a pair of time point and temperature. FIG. 14B illustrates an example of a result of the query.

A data adding and data searching procedure in a case where the data management system according to the present embodiment is used is as described above. Components and procedures required for updating the metadata system with the data management system are described below.

FIG. 5 illustrates the configuration of the metadata system management apparatus 3. For example, the metadata system management apparatus 3 includes an information processing unit 31, an input/output unit 32, a storage unit 33, and a communication interface unit 34 as in the configuration described above, and these units 31 to 34 are connected to each other through an internal bus. A user interface unit 35 is connected to the input/output unit 32. The communication interface unit 34 is connected to the communication network CN1. The storage unit 33 stores a computer program for implementing the metadata system management function 501.

FIG. 6 illustrates the configuration of the impact evaluation apparatus 2. For example, the impact evaluation apparatus 2 includes an information processing unit 21, an input/output unit 22, a storage unit 23, and a communication interface unit 24, and these units 21 to 24 are connected to each other through an internal bus. A user interface unit 25 is connected to the input/output unit 22. The storage unit 23 stores a computer program for implementing the impact evaluation function 201 and the query history DB 202.

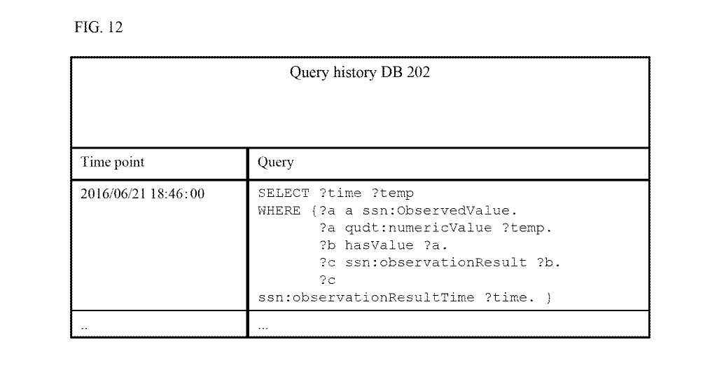

FIG. 12 illustrates an example of the configuration of the query history DB 202. Although a single query is illustrated in FIG. 12, the query history DB 202 actually stores a plurality of queries.

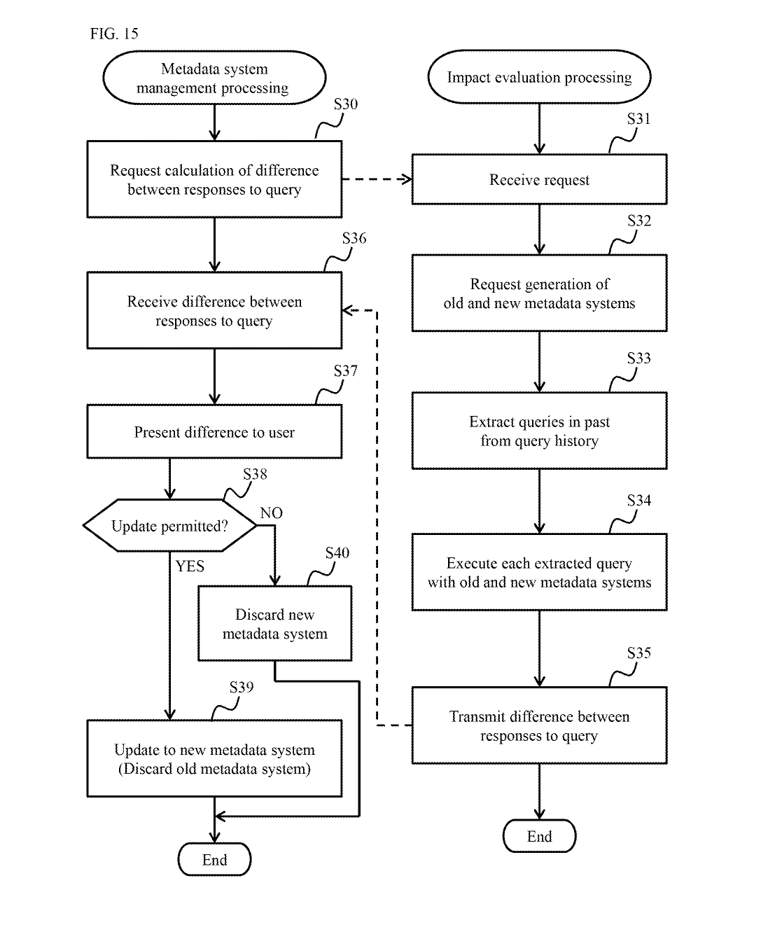

FIG. 15 is a flowchart illustrating processing executed by the metadata system management function 301 and processing executed by the impact evaluation function 201.

The user can change the metadata system set in the data storage apparatus 1 for performing more appropriate data analysis or the like. Here, it is assumed that a single metadata system can be set in the data storage apparatus 1 for the sake of description. However, this should not be construed in a limiting sense, and a plurality of metadata systems can be set in the data storage apparatus 1, so that the user can designate a metadata system used for searching for data.

Changing the metadata system by the user might make a large impact on the search result obtained. For example, the search result obtained by using the metadata system after the change might largely increase or largely decrease compared with the case where the metadata system before the change is used. However, a conventional technique fails to enable a user to recognize the level of impact of changing the metadata system, and thus requires a long period of time before the metadata system can be appropriately changed, leading to low usability. In view of this, in the present embodiment, an impact of a change is estimated and presented to the user before the change to the metadata system is confirmed.

As illustrated on the left side of FIG. 15, when the metadata system management apparatus 3 receives a metadata system change request from the user, the metadata system management function 301 requests the impact evaluation apparatus 2 to change the metadata system and to calculate the difference between responses to a query (S30).

Upon receiving the request from the metadata system management apparatus 3 (S31), the impact evaluation function 201 of the impact evaluation apparatus 2 requests the data storage apparatus 1 to prepare for two versions including an old metadata system 103(1) before the change is applied and a new metadata system 103(2) after the change is applied (S32).

The impact evaluation function 201 randomly extracts N queries (N>0) used in the past from the query history DB 202 (S33). An extraction method other than the random extraction, such as extraction of N latest queries may be employed.

The impact evaluation function 201 executes each query extracted in step S33 with the old metadata system 103(1) and for the new metadata system 103(2) (S34). The impact evaluation function 201 calculates a difference between a search result obtained by using the old metadata system 103(1) and a search result obtained by using the new metadata system 103(2) for the same query, and transmits the difference to the metadata system management apparatus as a response (S35).

Upon receiving the response from the impact evaluation apparatus 2 (S36), the metadata system management function 301 of the metadata system management apparatus 3 presents the difference, in the response, to the user who has issued the instruction to change the metadata system (S37). The user can determine whether to change (update) the old metadata system 103(1) to the new metadata system 103(2) by checking the difference. Changing the metadata system from the old system to the new system may be hereinafter referred to as “updating the metadata system”.

The metadata system management apparatus 3 receives an instruction from the user and determines whether the user has permitted the update (S38). When the user has permitted the update of the metadata system (S38: YES), an instruction to employ the new metadata system 103(2) is issued to the data storage apparatus 1 (S39). The old metadata system 103(1) may be discarded from the data storage apparatus 1, or may be maintained for a predetermined period.

When the user does not permit the update of the metadata system (S38:NO), the metadata system management function 301 issues an instruction to discard the new metadata system 103(2) to the data storage apparatus 1 (S40).

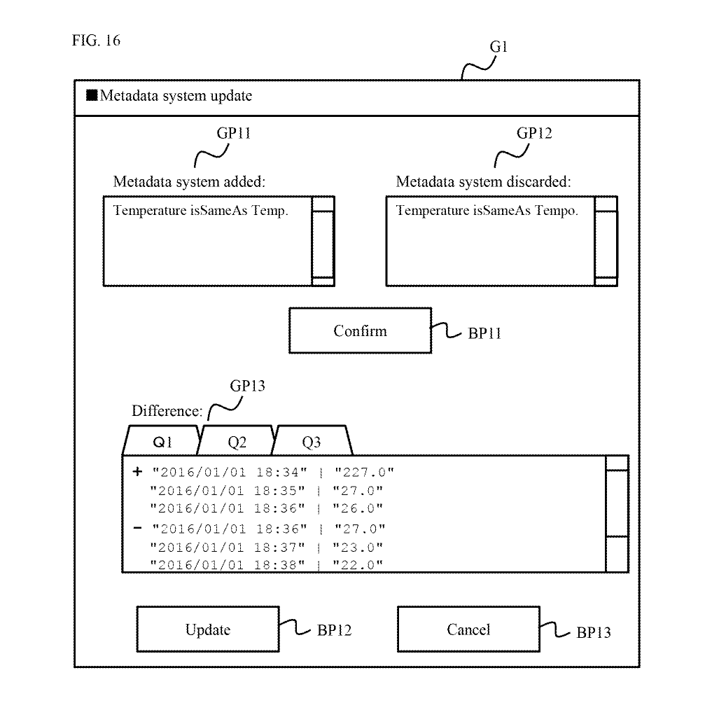

FIG. 16 illustrates an example of a screen G1 for managing the update of the metadata system. An example of the configuration of the screen G1 is described with reference to the flowchart in FIG. 15. The metadata system update management screen G1 is generated by the metadata system management function 301 of the metadata system management apparatus 3 and is presented to the user via the user interface unit 35 connected to the metadata system management apparatus 3.

For example, the metadata system update management screen G1 includes: changed point input units GP11 and GP12 for inputting a changed point in the metadata system; a difference display unit GP13 that displays the difference due to the change (update) of the metadata system; and buttons BP11 to BP13.

The changed point input units GP11 and GP12 include: an input unit GP11 for partially adding a metadata system; and an input unit GP12 for partially deleting a metadata system. The adding metadata system input unit GP11 is a display area in which the metadata system to be added to the currently operating metadata system 103(1) is input. The deleting metadata system input unit GP12 is a display area in which the metadata system to be deleted from the currently operating metadata system 103(2) is input.

When the user inputs a change in the currently operating metadata system 103(1) by using one of the input units GP11 and GP12 or both and then presses a confirm button BP11, the metadata system management function 301 receives the change request from the user.

Then, as described above with reference to FIG. 15, the impact evaluation function 201 causes the data storage apparatus 1 to prepare the currently operating metadata system 103(1) as well as the new metadata system 103(2) reflecting the changed point desired by the user (S31 and S32). The impact evaluation function 201 causes the search for the predetermined number of queries selected with a predetermined method (S33) in the old metadata system 103(1) and in the new metadata system 103(2) (S34). Then, the impact evaluation function 201 calculates the difference between the search result obtained by using the old metadata system 103(1) and the search result obtained by using the new metadata system 103(2), and transmits the difference to the metadata system management function 301 (S35).

Upon receiving the difference from the impact evaluation function 201 (S36), the metadata system management function 301 displays the difference on the difference display unit GP13. The difference display unit GP13 displays a newly detected search result and a lost search result for each query.

In FIG. 16, “Q1”, “Q2”, and “Q3” each represents a query used for examining an impact due to the change in the metadata system. The user can check the difference in the search result for each query by switching a tab menu. A “+” mark is displayed at the top of the newly detected result (added data) which has not been obtained with the metadata system before the change 103(1). A “−” mark is displayed at the top of the lost search result (deleted data) which has been lost from the result obtained by using the metadata system before the change 103(1). Any mark can be used as long as increased and reduced search results can be clearly recognized.

The user can determine whether to update or cancel the update of the metadata system, after checking the content displayed on the difference display unit GP13. A user who desires to update the currently operating metadata system presses an update button BP12. A user who desires to cancel or redo the update of the currently operating metadata system presses a cancel button BP13. The user can repeat the inputting of the changed point in the metadata system and the checking of the difference in the search result to achieve the metadata system desired by the user.

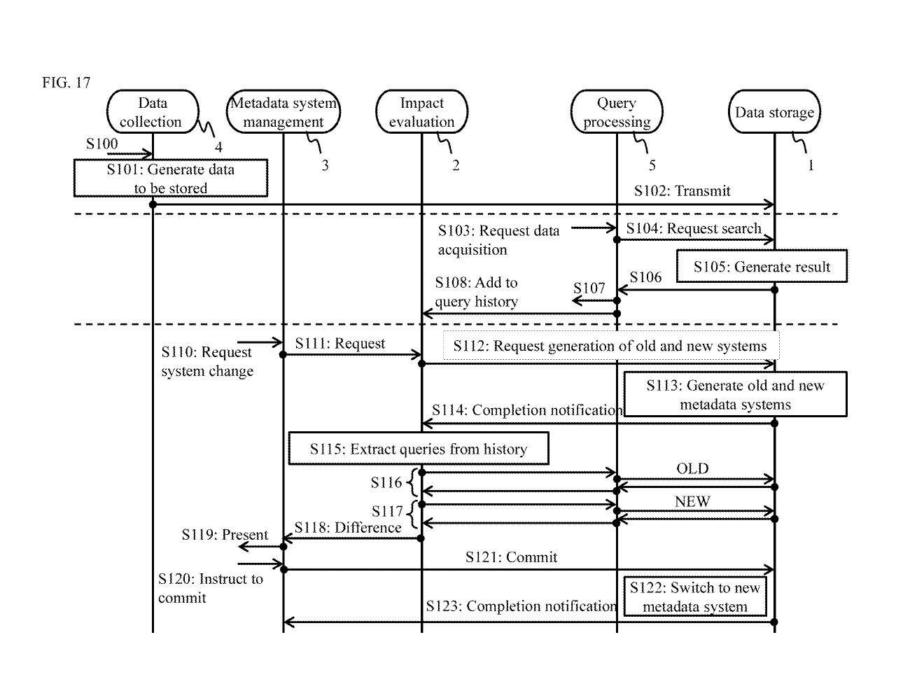

FIG. 17 illustrates a typical sequence executed in accordance with the processing procedure described above. In FIG. 17, the data generation apparatus 6 and the data using apparatus 7 are omitted.

Steps S100 to S102 are data registration sequence. When the raw data arrives from the data generation apparatus 6 (S100), the data collection apparatus 4 uses the template DB 402 to generate data to be stored in the data storage apparatus 1 (S101). The data generated by applying the raw data to a template is transmitted from the data collection apparatus 4 to the data storage apparatus 1 to be stored (S102).

Steps S103 to S108 represent a sequence in a case where the data using apparatus 7 requests the data search. Upon receiving the data acquisition request from the data using apparatus 7 (S103), the query processing apparatus 5 transmits the search request to the data storage apparatus 1 (S104). The data storage apparatus 1 processes the search request to generate a search result (S105). The data storage apparatus 1 transmits the search result to the query processing apparatus 105 as a response (S106). The query processing apparatus 5 transmits the acquired result to the data using apparatus 7 as a response (S107). The query content is transmitted from the query processing apparatus 5 to the impact evaluation apparatus 2 to be registered in the query history DB 202 (S108).

Steps S110 to S123 represent a sequence related to the updating of the metadata system. Upon receiving the change request for the metadata system (S110), the metadata system management apparatus 3 transmits a difference obtaining request to the impact evaluation apparatus 2 (S111). The impact evaluation apparatus 2 notifies the data storage apparatus 1 of the changed point in the metadata system, and requests the preparation of the two versions of metadata systems that are old and new (S112). Upon receiving the request in step S112, the data storage apparatus 1 prepares the two versions of metadata systems that are old and new (S113), and notifies the impact evaluation apparatus 2 of the completion of the preparation (S114).

The impact evaluation apparatus 2 extracts the N past queries from the query history DB 202 (S115), and instructs the query processing apparatus to process each query in the two versions of the metadata systems that are old and new (S116, S117). In FIG. 17, issuing of the query to the old metadata system 103(1) and reception of the search result are performed in step S116, and issuing of the query to the new metadata system 103(2) and the reception of the search result are executed in step S117.

The query processing apparatus 5 transmits a search request to the data storage apparatus 1 and transfers a search result, as a response to the search request, to the impact evaluation apparatus 2. The impact evaluation apparatus 2 obtains the difference (difference in the search result) in the response between the old and the new metadata systems applied to the same query group, and transmits the difference to the metadata system management apparatus 3 as a response (S118).

The metadata system management apparatus 3 presents the difference, received from the impact evaluation apparatus 2, to the user (S119), and waits for an instruction from the user. Here, it is assumed that the user has permitted the update. Upon receiving the permission to update from the user (S120), the metadata system management apparatus 3 issues an instruction indicating that the new metadata system 103(2) is to be used and that the old metadata system 103(1) is to be discarded, to the data storage apparatus 1 (S121).

The data storage apparatus 1 follows the instruction from the metadata system management apparatus 3, and thus switches the metadata system to be operated from the old metadata system 103(1) to the new metadata system 103(2) (S122). Then, the data storage apparatus 1 notifies the metadata system management apparatus 3 of the completion of the switching of the metadata system (S123).

With the present embodiment having the configuration described above, when the user attempts to change a metadata system, an impact on the search result due to the change can be estimated in advance. Thus, the user can issue an instruction to execute update processing for the metadata system, after reviewing the potential impact, and thus can enjoy higher usability. Furthermore, the user can search for data while correcting the metadata system, and thus can achieve an appropriate data analysis.

### Embodiment 2

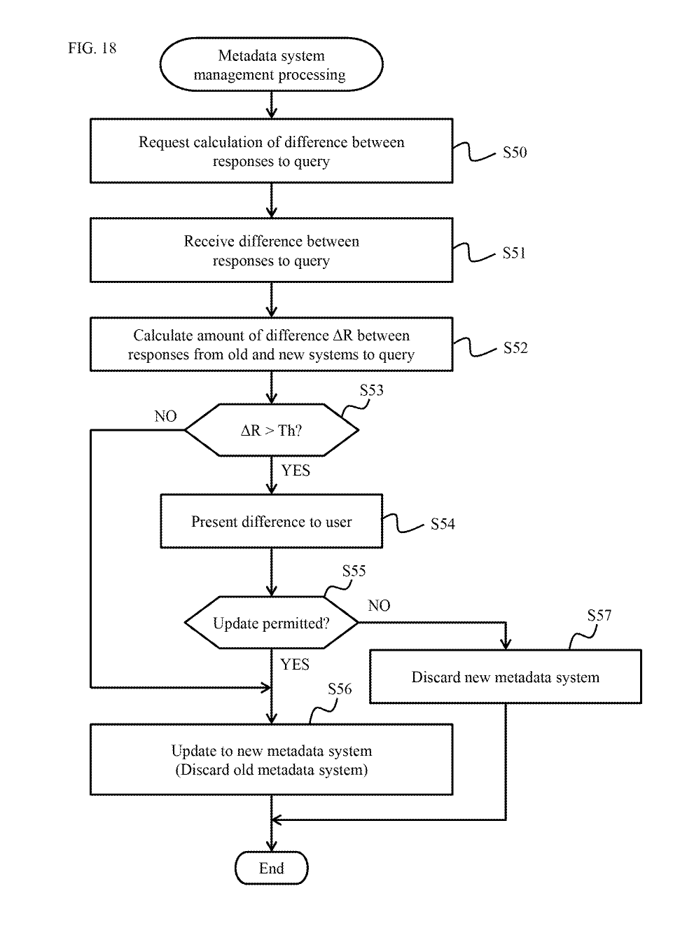

Embodiment 2 is described with reference to FIG. 18. This embodiment as well as other embodiments described below are modifications of Embodiment 1, and thus are described while mainly focusing on the difference from Embodiment 1.

In Embodiment 1, the impact of the update of the metadata system is presented to the user in a form of a difference in the search result between the old and the new metadata systems applied to the same query.

In Embodiment 2, the content of the difference presented to the user is changed in accordance with an amount of the difference with respect to the query. In the present embodiment, the metadata system is automatically updated when the difference is small and thus an impact on the search is small, to save time and effort of the user.

FIG. 18 is a flowchart illustrating processing executed by the metadata system management function 301 in the present embodiment. In FIG. 18, the processing executed by the impact evaluation function 201 and the like are omitted.

Upon receiving the update instruction for the metadata system from the user, the metadata system management function 301 of the metadata system management apparatus 3 requests the impact evaluation apparatus 2 to calculate the difference in the search result between the old and the new metadata systems applied to the same query (S50). Then, the metadata system management function 301 receives the difference with respect to the query as a response from the impact evaluation function 201 (S51).

The metadata system management function 301 calculates an amount of the difference ΔR (S52). For example, the metadata system management function 301 calculates the number of added, deleted, and updated data sets for each query to obtain the difference amount ΔR (S52). Specifically, the metadata system management function 301 obtains the difference amount ΔR as a sum or the like of the number of newly added data sets, the number of deleted data sets, and the number of data sets the content of which has been changed, in the search result as a result of applying the old and the new metadata systems to the same query.

The metadata system management function 301 checks whether the difference amount ΔR calculated in step S52 is larger than a predetermined threshold Th (S53). When the calculated difference amount ΔR is equal to or smaller than the threshold Th (S53: NO), the metadata system management function 301 determines that the range of the impact is small, and thus switches the old metadata system 103(1) to the new metadata system 103(2) (S56).

When the difference amount ΔR calculated in step S52 is larger than the threshold Th (S53: YES), the metadata system management function 301 regards the range of the impact as being large and thus presents the difference to the user to urge the user to determine whether the metadata system can be updated (S54). Then, the update instruction from the user is checked as in Embodiment 1 described above (S55). When the user permits the update (S55: YES), the metadata system management function 301 switches the system to the new metadata system 103(2) (S56). When the user cancels the update (S55: NO), the metadata system management function 301 causes the discarding of the new metadata system 103(2) (S57).

This embodiment with the configuration described above also provides advantageous effects similar to those of Embodiment 1. The present embodiment has an additional feature that the metadata system is automatically updated when the difference amount ΔR, as a result of executing the same query with the old and the new metadata systems, is equal to or smaller than the threshold Th. Thus, the usability can further be improved with the time effort of the user saved when the impact of the switching of the metadata system is small.

### Embodiment 3

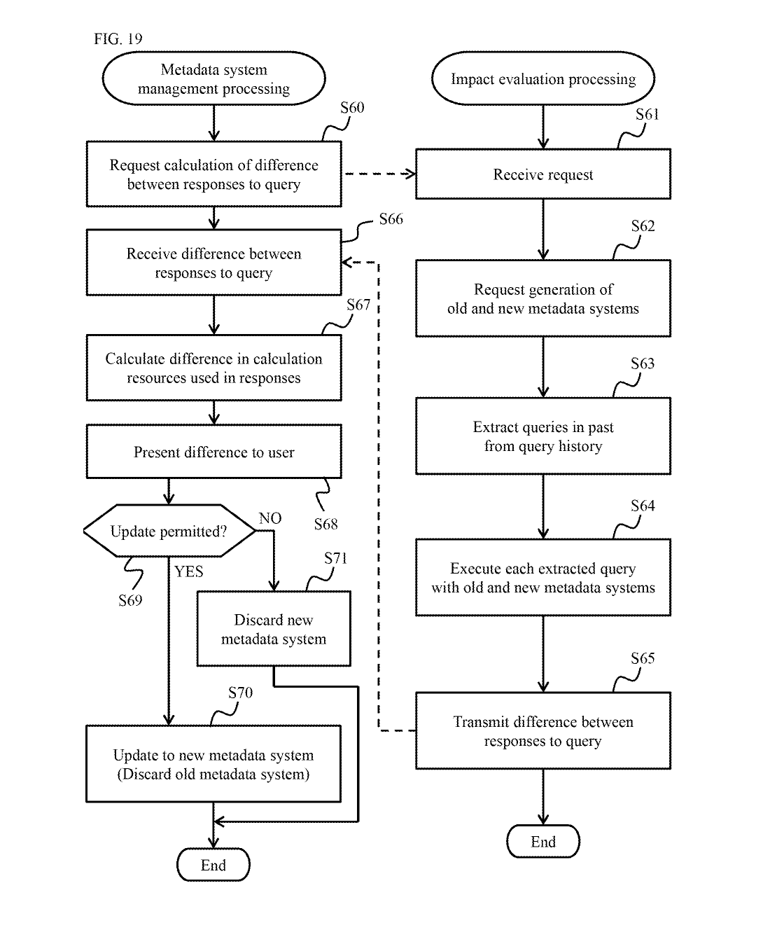

Embodiment 3 is described with reference to FIG. 19. In the present embodiment, the difference, as a result of executing the same query with the old and the new metadata systems, is evaluated with an amount of calculation resources used for the data search. This is because even when the change of the metadata system does not involve a large difference in the search result, the amount of calculation resources required for the search might be largely different. For example, the amount of calculation resources can be evaluated with a calculation time, a processor utilization rate, an amount of consumed memory, and the like required for the search.

Comparison between a flowchart illustrated in FIG. 19 and the flowchart illustrated in FIG. 15 indicates that steps S60 to S63 in FIG. 19 correspond to steps S30 to S33 in FIG. 15. Thus, the description on steps S60 to S63 is omitted.

The present embodiment additionally provides a function of retuning the search result, for the search processing executed in the data storage apparatus 1, including information on the calculation resources used in the search. Such a function can be implemented by using a resource management function of an operating system of a general computer. An example of the resource management function includes a vmstat command, a time command, and a ps command of the operating system as well as a job management function of a cluster management system.

In the present embodiment, the impact evaluation function 201 does not receive the query result but receives the used amount of calculation resources involved in the search using the old and the new metadata systems, as the result of the query executed in step S64. Then, the impact evaluation function 201 transmits the difference in the used amount of the calculation resources to the metadata system management function 301 (S65).

Upon receiving the difference from the impact evaluation function 201 (S66), the metadata system management function 301 calculates the difference in the calculation resources used in the old and the new metadata systems (S67), and presents the difference in the calculation resources calculated in step S67 to the user (S68).

The user can determine whether to update the metadata system by checking the variance between the calculation resource amount required for the search using the old metadata system 103(1) and the calculation resource amount required for the search using the new metadata system 103(2).

When the user permits the update (S69: YES), the metadata system management function 301 instructs the data storage apparatus 1 to update the old metadata system 103(1) with the new metadata system 103(2) (S70). When the user does not permit the update (S69: NO), the metadata system management function 301 instructs the data storage apparatus 1 to discard the new metadata system 103(2) (S71).

This embodiment with the configuration described above also provides advantageous effects similar to those of Embodiment 1. The present embodiment has an additional feature that the impact of changing the old metadata system to the new metadata system is calculated as the used amount of the calculation resources, and thus whether to permit the change can be determined based on the used amount of the calculation resources. Thus, the user can enjoy even higher usability.

Even when the difference in the data search result is not very large, the amount of calculation resources used for obtaining the result might largely differ. In a data management system involving a large variety of data, the used amount of calculation resources might largely fluctuate. Even in such a case, the data management system according to the present embodiment can be applied to improve the usability.

### Embodiment 4

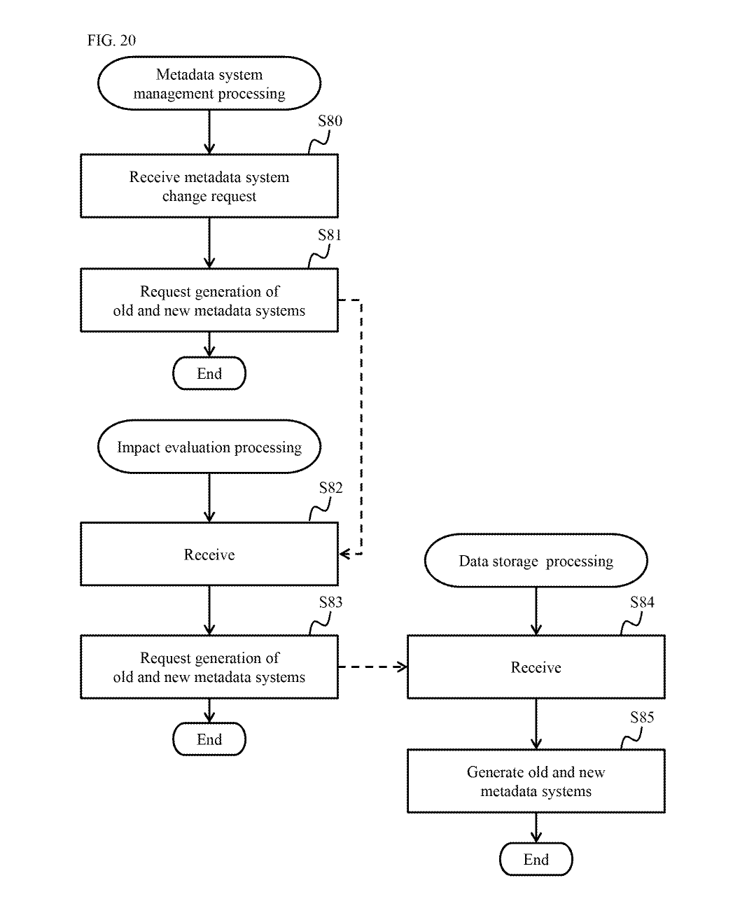

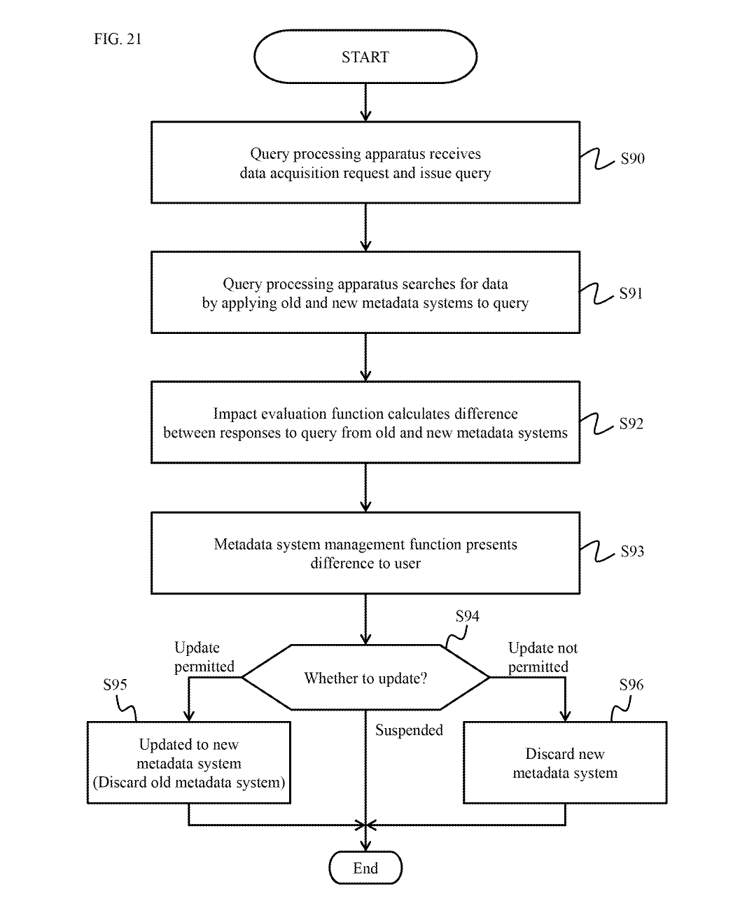

Embodiment 4 is described with reference to FIGS. 20 and 21. In the present embodiment, not the impact of changing the old metadata system to the new metadata system in a short period of time but the impact of changing the metadata system while the old and the new metadata systems are concurrently operated is checked.

FIG. 20 is a flowchart illustrating a preparation step for concurrently operating the old and the new metadata systems. Upon receiving the metadata system change request from the user (S80), the metadata system management function 301 requests the impact evaluation function 201 to prepare the old and the new metadata systems (S81).

Upon receiving the request from the metadata system management function 301 (S82), the impact evaluation function 201 requests the data storage apparatus 1 to generate the old and the new metadata systems (S83). Upon receiving the request from the impact evaluation function 201 (S84), the data storage apparatus 1 generates the old and the new metadata systems (S85). The old metadata system 103(1) is the currently operating metadata system and thus already exists. Still, the data storage apparatus 1 may prepare the copy of the old metadata system for investigation use for checking the impact.

FIG. 21 is a flowchart of processing for determining whether the update is permitted, by checking the impact of changing the metadata system while the old and the new metadata systems are being concurrently operated.

Upon receiving a data acquisition request from the data using apparatus 7 (S90), the query processing apparatus 5 issues a query to the data storage apparatus 1. The data storage apparatus 1 searches for data by applying each of the old and the new metadata systems to the query (S91).

The impact evaluation function 201 calculates the difference between the search result by using the new metadata system and the search result obtained by using the old metadata system (S92), and transmits the result to the metadata system management function 301.

The metadata system management function 301 presents the received difference to the user (S93), and waits for the instruction from the user (S94). The user checks the presented difference, and issues an instruction to permit or not to permit the update of the metadata system or to suspend the decision, to the metadata system management function 301.

When the user permits the update, the metadata system management function 301 instructs the data storage apparatus 1 to perform the update to the new metadata system (S95). When the user does not permit the update, the metadata system management function 301 instructs the data storage apparatus 1 to discard the new metadata system (S96).

When the user suspends the decision to permit or not to permit the update, the metadata system management function 301 terminates the processing. A button for issuing the instruction indicating that the decision is suspended may be added to the screen G1 illustrated in FIG. 16, or it may be determined that the decision has been suspended when none of the update button BP12 or the cancel button BP13 is pressed by the user within a predetermined period of time.

In step S93, the metadata system management function 301 may present only the difference related to the latest query to the user, or may present, for example, the history of the difference or a cumulated value of the difference related to the queries issued within a predetermined period of time to the user. The screen G1 may be provided with buttons and the like or a display section for displaying, for example, the history or the cumulated value of the difference.

This embodiment with the configuration described above also provides advantageous effects similar to those of Embodiment 1. The present embodiment has an additional feature that the difference with respect to the query can be monitored with the old and the new metadata systems concurrently operated. Thus, the user can determine whether to update the metadata system based on the monitoring result in the actual operation, and thus can more accurately review the range of the impact of changing the metadata system, compared with the case where the difference is examined with a group of test queries.

### Embodiment 5

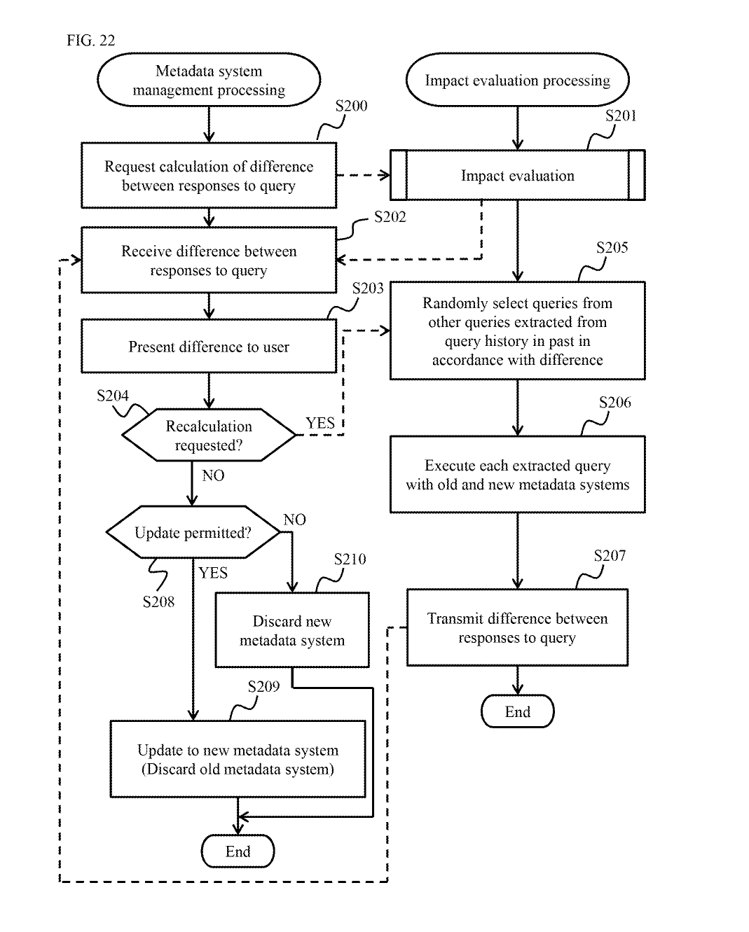

Embodiment 5 is described with reference to FIG. 22. In the present embodiment, the impact of changing the metadata system can be calculated for a plurality of times, in accordance with a user request.

FIG. 22 is a flowchart illustrating processing executed by the metadata system management function 301 and processing executed by the impact evaluation function 201.

Upon receiving the change request for the metadata system, the metadata system management function 301 requests the impact evaluation function 201 to calculate the difference in the case where the old and the new metadata systems are applied to the same query (S200).

Upon receiving the request from the metadata system management function 301, the impact evaluation function 201 evaluates the impact of changing the metadata system as described above with reference to steps S31 to S35 in FIG. 15 (S201).

Specifically, the impact evaluation function 201 instructs the data storage apparatus 1 to prepare the old and the new metadata systems, randomly extracts the queries used in the past from the query history DB 202 for a predetermined number of times, executes data search with the old and the new metadata systems applied to the queries, and receives the difference as a response from the data storage apparatus 1 (S201). Then, the impact evaluation function 201 transmits the difference as the response to the metadata system management function 301 (S201).

Upon receiving the difference as a response related to the old and the new metadata systems (S202), the metadata system management function 301 presents the difference to the user (S203). The difference as a response may be the difference in the content of the response, the number of differences (the number of hits), or the used amount of the calculation resources.

The user can determine whether to change (update) the metadata system by checking the impact evaluation presented by the metadata system management function 301. The user may be unable to determine whether to change the metadata system in a case where the difference is small for example.

Thus, in the present embodiment, the impact evaluation can be repeated. The metadata system update screen G1 illustrated in FIG. 16 may be additionally provided with a button for instructing recalculation to the metadata system management function 301 by the user. The instruction for the recalculation may be issued with voice or the like of the user instead of using the button. When the user requests the recalculation, the metadata system management function 301 requests the impact evaluation function 201 to perform the recalculation (S204: YES).

The impact evaluation function 201 randomly selects a predetermined number of queries other than the query used for first impact evaluation from the query history DB 202 in accordance with the difference obtained in the first impact evaluation (S205). The impact evaluation function 201 selects the query used in second impact evaluation in accordance with the difference obtained in the first impact evaluation. For example, when the first difference is smaller than a predetermined value set in advance, the impact evaluation function 201 may select a query similar or related to the first query. For example, when the content of the first query is “average temperature in A region”, “average power consumption in A region”, or “average temperature of a section as a part of A region” may be selected as the second query.

The impact evaluation function 201 searches for data with the reselected query (another query) executed to each of the old and the new metadata systems (S206). The impact evaluation function 201 transmits a difference in the response between cases where the query is applied to the old and the new metadata systems to the metadata system management function 301 (S207).

Upon receiving the difference obtained by the second impact evaluation (S202), the metadata system management function 301 presents the difference to the user (S203). The user may check the result of the second impact evaluation, and then issue an instruction to perform a third impact evaluation (S204: YES).

The user may not issue an instruction to execute a further impact evaluation (S204: NO), and permit the update of the metadata system (S208: YES). Upon receiving the permission from the user, the metadata system management function 301 instructs the data storage apparatus 1 to update the old metadata system with the new metadata system (S209). When the user does not permit the update (S209: NO), the metadata system management function 301 instructs the data storage apparatus 1 to discard the new metadata system (S210).

This embodiment with the configuration described above also provides advantageous effects similar to those of Embodiment 1. The present embodiment has an additional feature that the impact of changing the metadata system can be evaluated for a plurality of times with queries of different contents.

In the present embodiment, the query content related to the previous query content or the query content similar to the previous query content is randomly extracted from the query history DB 202 to be used in the current impact evaluation, and thus the impact of changing the metadata system can be more appropriately recognized.

### Embodiment 6

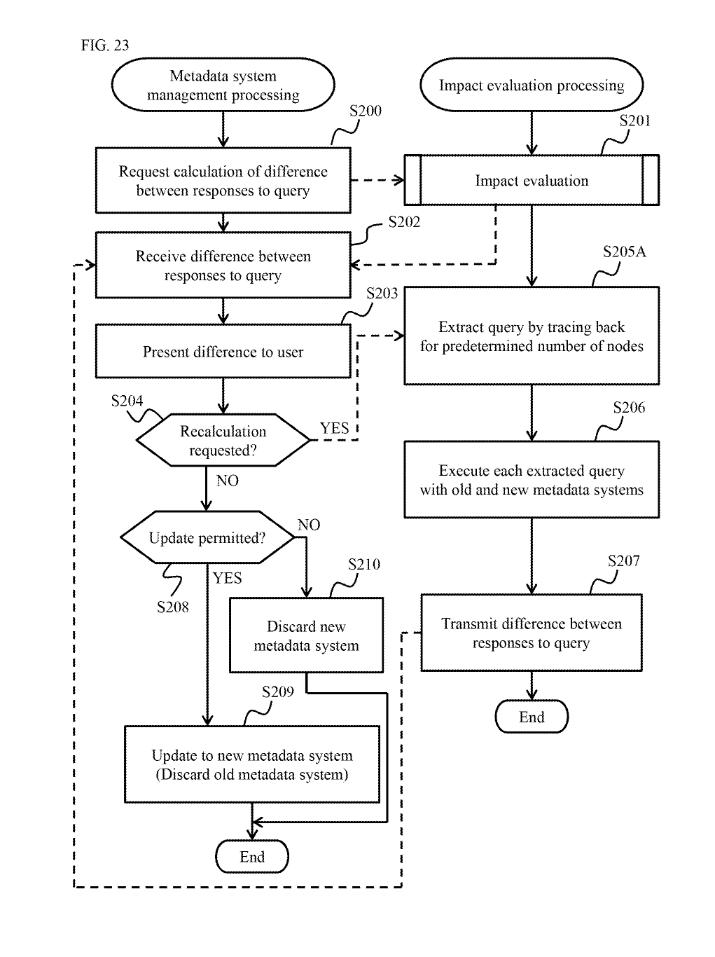

Embodiment 6 is described with reference to FIG. 23. In the present embodiment, the query used in the current impact evaluation is determined by tracing back the query used for previous impact evaluation to a predetermined node destination. Here, a node is an element described as subject or object in the data stored in the raw data+provided metadata DB 102 or the metadata system DB 103. Search of another element associated with each of these elements by predicate is referred to as “tracing back the node”.

FIG. 23 is a flowchart illustrating processing executed by the metadata system management function 301 and processing executed by the impact evaluation function 201, according to the present embodiment. The flowchart has steps described above with reference to FIG. 22, except for step S205A.

For example, in step S205A in the flowchart, when “temperature” is used as the previous query content, a query including “sensor type” obtained by tracing back “temperature” in the raw data+provided metadata DB 102 or the metadata system DB 103 for a predetermined number of nodes is selected as the current query content. This embodiment with the configuration described above also provides advantageous effects similar to those of Embodiment 6.

The embodiments described above may be implemented individually, or some of the embodiments may be implemented in combination as appropriate. Although the embodiments have been described with different functions performed in respective apparatuses, the present invention is not limited to this. These functions and DBs may be implemented in any other distribution form while the relations for calling the functions are maintained.

The present invention is not limited to the embodiments described above, but includes various modifications. The embodiments are described in detail for easy understanding of the present invention, and are not intended to limit the present invention to the one including all the components described above. At least part of the components of each embodiment may be provided with an additional component, and have some components omitted or replaced with other components, without departing from the spirit and scope of the claimed subject matter.

Part or the whole of the above-described components, functions, processing units, processors, and the like may be implemented in hardware, such as integrated circuits designed to achieve these, for example. The present invention may also be implemented by program codes for software implementing the functions of the embodiments. In this case, a computer is provided with a recording medium storing a program code and a CPU in the computer reads the program code stored in the recording medium. In this case, the program code itself read from the recording medium implements the functions of the embodiments described above, and the program code itself and the recording medium storing the program code constitute the present invention. Examples of the recording medium for providing the program code include flexible disks, CD-ROMs, DVD-ROMs, hard disks, SSDs (Solid State Drives), optical discs, magneto optical discs, CD-Rs, magnetic tapes, nonvolatile memory cards, ROMs, and the like.

Although the present disclosure has been described with reference to exemplary embodiments, those skilled in the art will recognize that various changes and modifications may be made in form and detail without departing from the spirit and scope of the claimed subject matter.

What is claimed is:

1. A data management system that manages data including metadata, the system comprising:
a data storage unit configured to store: a data group that is a group of data provided with at least one metadata; and one or more metadata systems for interpreting the metadata, and to search for the data group with a selected metadata system, in accordance with a query;
an impact evaluation unit configured to obtain a variance between a plurality of metadata systems serving as comparison targets when the plurality of metadata systems execute a same query for the data storage unit; and
a metadata system management unit configured to select a metadata system from the plurality of metadata systems serving as the comparison targets, based on the variance obtained by the impact evaluation unit.

2. The data management system according to claim 1, wherein the metadata system management unit is configured to set the selected metadata system as a metadata system of the data storage unit.

3. The data management system according to claim 1, wherein the metadata system management unit is configured to present the variance to a user and select, from the plurality of metadata systems serving as the comparison targets, a metadata system based on an instruction from the user.

4. The data management system according to claim 1, wherein the data storage unit is configured to generate at least a portion of the plurality of metadata systems serving as the comparison targets, in accordance with a query from the impact evaluation unit.

5. The data management system according to claim 1, wherein
the impact evaluation unit is configured to issue a query to the data storage unit in accordance with an instruction from the user, and
the data storage unit is configured to generate, in accordance with the query from the impact evaluation unit, another metadata system different from the metadata system set to the data storage unit, and to set the metadata system set to the data storage unit and the other metadata system as the plurality of metadata systems serving as the comparison targets.

6. The data management system according to claim 1, wherein the impact evaluation unit is configured to obtain, as the variance, a content of difference in response to the same query between the plurality of metadata systems serving as the comparison targets.

7. The data management system according to claim 1, wherein the impact evaluation unit is configured to obtain, as the variance, an amount of difference in response to the same query between the plurality of metadata systems serving as the comparison targets.

8. The data management system according to claim 1, wherein the impact evaluation unit is configured to obtain, as the variance, a difference in amount of calculation resources consumed for processing the same query between the plurality of metadata systems serving as the comparison targets.

9. The data management system according to any one of claim 1, wherein the impact evaluation unit is configured to select a query for obtaining the variance from a history of queries executed in past with the data storage unit.

10. The data management system according to claim 1, wherein the impact evaluation unit is configured to select the other metadata system generated by the data storage unit, when the variance is equal to or smaller than a predetermined value.

11. The data management system according to claim 1, wherein
the metadata system management unit is configured to concurrently operate the plurality of metadata systems serving as the comparison targets, to cause the impact evaluation unit to obtain a variance between the plurality of metadata systems serving as the comparison targets when the plurality of metadata systems execute the same query, and to present the variance to the user.

12. The data management system according to claim 1, wherein
the metadata system management unit is configured to instruct, when a user issues an instruction for recalculation after the variance is presented to the user, the impact evaluation unit to obtain again a variance between the plurality of metadata systems serving as the comparison targets when the plurality of metadata systems execute another same query,
the impact evaluation unit is configured to select another query different from the first used query from a past query history, and to obtain again a variance between the plurality of metadata systems serving as the comparison targets when the plurality of metadata systems execute the other same query for the data storage unit, and
the metadata system management unit is configured to select any one of the plurality of metadata systems serving as the comparison targets, based on the variance obtained again by the impact evaluation unit.

13. The data management system according to claim 12, wherein the impact evaluation unit is configured to select the other query in accordance with the variance corresponding to the first used query.

14. A data management method for managing data including metadata by a computer, the method causing the computer to:
store a data group that is a group of data provided with at least one metadata, and one or more metadata systems for interpreting the metadata;
search for the data group with a selected metadata system, in accordance with a query;
obtain a variance between a plurality of metadata systems serving as comparison targets when the plurality of metadata systems execute a same query; and
select a metadata system from the plurality of metadata systems serving as the comparison targets, based on the obtained variance.
